(19) United States
(12) Patent Application Publication
(10) Pub. No.: US 2016/0294936 A1
(43) Pub. Date: Oct. 6, 2016

(54) Method, Service Providing Server, and Computer Program for Controlling Content Transmission Between User Terminals Around Wireless Communication Module

(71) Applicant: Quoin, Inc., Seoul (KR)

(72) Inventor: Tae Sook Lee, Seoul (KR)

(21) Appl. No.: 14/700,794

(22) Filed: Apr. 30, 2015

(30) Foreign Application Priority Data
Apr. 2, 2015 (KR) 10-2015-0047034

(51) Int. Cl. H04L 29/08; H04L 12/18

(52) U.S. Cl. CPC H04L 67/1055; H04L 12/189; H04L 12/185

(57) ABSTRACT

A method for a service providing server to control content transmission between user terminals around a wireless communication module includes registering a first user account as an adjacent user of the wireless communication module when identification information of the wireless communication module is received from a first user terminal having recognized the wireless communication module, providing an adjacent user list of the wireless communication module to the first user terminal, receiving selection information of a second user who is at least one user in the adjacent user list from the first user terminal, and connecting the first user account and a second user account to control content transmission so that content is transmitted between the first user terminal and the second user terminal.

### CROSS-REFERENCE TO RELATED APPLICATION

This application claims the benefit under 35 U.S.C. §119 of Korean Application No. 10-2015-0047034, filed Apr. 2, 2015, which is hereby incorporated by reference in its entirety.

### BACKGROUND

1. Field of the Invention

The present invention relates to a method for controlling content transmission between user terminals around a wireless communication module and a service providing server, and more particularly, to a method for a service providing server to control content transmission between user terminals around a wireless communication module, a method for a first user terminal to transmit content to a second user terminal around a wireless communication module, a service providing server for controlling content transmission between user terminals around a wireless communication module, and a computer program.

2. Related Art

As smart devices have become common and their usage is increasing recently, a variety of applications are installed and used in the smart devices. In particular, social network service (SNS) applications, such as KakaoTalk, Facebook, and Twitter, are widely used by users.

According to existing SNS applications, friends are registered based on existing relationships which have been established already, and it is difficult to establish a new relationship in addition to existing relationships.

Meanwhile, various services, such as a beacon service and a near field communication (NFC) service, are provided using a wireless communication module. However, a wireless communication module disposed at a specific place is used to provide information relating to the place (e.g., coupon information of a store), and thus is limited to the provision of information on objects.

Consequently, there is an increasing demand for establishing new relationships with nearby people in addition to existing relationships while expanding a service employing a wireless communication module so that people around the wireless communication module recognize each other, and a solution to the aforementioned problem is necessary as soon as possible.

### SUMMARY OF THE INVENTION

The present invention is directed to providing a method, a service providing server, and a computer program for controlling content transmission so that content is transmitted between user terminals around a wireless communication module.

Objects of the present invention are not limited to those mentioned above, and other objects not mentioned above will be clearly appreciated from description below.

According to an aspect of the present invention, there is provided a method for a service providing server to control content transmission between user terminals around a wireless communication module, the method including: when identification information of the wireless communication module is received from a first user terminal having recognized the wireless communication module, registering a first user account as an adjacent user of the wireless communication module; providing an adjacent user list of the wireless communication module to the first user terminal; receiving selection information of a second user who is at least one user in the adjacent user list from the first user terminal; and connecting the first user account and a second user account and controlling content transmission so that content is transmitted between the first user terminal and the second user terminal.

The registering of the first user account as an adjacent user may include registering the first user account having logged into a first application as an adjacent user of the wireless communication module, and the providing of the adjacent user list may include providing the adjacent user list including the second user account having logged into a second application to the first user terminal.

The controlling of the content transmission may include controlling the content transmission so that the content is transmitted between the first application and the second application.

The controlling of the content transmission may include controlling the content transmission so that content requested for transmission by the first user terminal through the first application is displayed in the second user terminal through the second application and content requested for transmission by the second user terminal through the second application is displayed in the first user terminal through the first application.

The controlling of the content transmission may include controlling the content transmission so that the content transmitted between the first application and the second application is displayed in the first user terminal and the second user terminal through a push message.

The controlling of the content transmission may include controlling the content transmission so that the content transmitted between the first user terminal and the second user terminal is displayed in a chat window accessed by the first user account and the second user account.

The controlling of the content transmission may include controlling the content transmission so that the content transmitted between the first user terminal and the second user terminal is displayed in an online bulletin board provided to adjacent users of the wireless communication module.

The providing of the adjacent user list may include providing the first user terminal with the adjacent user list having been subjected to at least one of filtering and arrangement based on interest information set in the first user account and the second user account.

The providing of the adjacent user list may include providing the first user terminal with the adjacent user list arranged according to distances between the wireless communication module, the first user terminal, and the second user terminal based on location information of the wireless communication module, the first user terminal, and the second user terminal.

The controlling of the content transmission may include controlling the content transmission so that the content is transmitted between the first user terminal and the second user terminal even when at least one of the first user account and the second user account is released from adjacent users of the wireless communication module after the first user account and the second user account are connected.

According to another aspect of the present invention, there is provided a method for a first user terminal to transmit content to a second user terminal around a wireless communication module, the method including: when the first user terminal is within a wireless communication range of the wireless communication module, receiving identification information from the wireless communication module to recognize the wireless communication module; transmitting the identification information of the wireless communication module to a service providing server and receiving an adjacent user list of the wireless communication module from the service providing server; when a second user who is at least one user in the adjacent user list is selected, transmitting selection information of the second user to the service providing server; and when a first user account and a second user account are connected by the service providing server, transmitting content to be transmitted to the second user account to the service providing server, so that the content is transmitted to the second user terminal.

According to still another aspect of the present invention, there is provided a service providing server for controlling content transmission between user terminals around a wireless communication module, the service providing server including: an adjacent user registration unit configured to register a first user account as an adjacent user of the wireless communication module when identification information of the wireless communication module is received from a first user terminal having recognized the wireless communication module; an adjacent user list providing unit configured to provide an adjacent user list of the wireless communication module to the first user terminal; a user selection information receiving unit configured to receive selection information of a second user who is at least one user in the adjacent user list from the first user terminal; and a content transmission control unit configured to connect the first user account and a second user account and control content transmission so that content is transmitted between the first user terminal and a second user terminal.

The adjacent user registration unit may register the first user account having logged into a first application as an adjacent user of the wireless communication module, and the adjacent user list providing unit may provide the adjacent user list including the second user account having logged into a second application to the first user terminal.

The content transmission control unit may control the content transmission so that the content is transmitted between the first application and the second application.

The content transmission control unit may control the content transmission so that content requested for transmission by the first user terminal through the first application is displayed in the second user terminal through the second application and content requested for transmission by the second user terminal through the second application is displayed in the first user terminal through the first application.

The content transmission control unit may control the content transmission so that the content transmitted between the first application and the second application is displayed in the first user terminal and the second user terminal through a push message.

The content transmission control unit may control the content transmission so that the content transmitted between the first user terminal and the second user terminal is displayed in a chat window accessed by the first user account and the second user account.

The content transmission control unit may control the content transmission so that the content transmitted between the first user terminal and the second user terminal is displayed in an online bulletin board provided to adjacent users of the wireless communication module.

The adjacent user list providing unit may provide the first user terminal with the adjacent user list having been subjected to at least one of filtering and arrangement based on interest information set in the first user account and the second user account.

The adjacent user list providing unit may provide the first user terminal with the adjacent user list arranged according to distances between the wireless communication module, the first user terminal, and the second user terminal based on location information of the wireless communication module, the first user terminal, and the second user terminal.

The content transmission control unit may control the content transmission so that the content is transmitted between the first user terminal and the second user terminal even when at least one of the first user account and the second user account is released from adjacent users of the wireless communication module after the first user account and the second user account are connected.

According to yet another aspect of the present invention, there is provided a computer program for a first user terminal to perform: a function of receiving identification information from a wireless communication module to recognize the wireless communication module when the first user terminal is within a wireless communication range of the wireless communication module; a function of transmitting the identification information of the wireless communication module to a service providing server and receiving an adjacent user list of the wireless communication module from the service providing server; a function of transmitting selection information of a second user to the service providing server when the second user who is at least one user in the adjacent user list is selected; and a function of transmitting content to be transmitted to a second user account to the service providing server when a first user account and the second user account are connected by the service providing server, so that the content is transmitted to the second user terminal.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram showing a content transmission system according to an exemplary embodiment of the present invention;

FIG. 2 is a block diagram of a service providing server according to an exemplary embodiment of the present invention;

FIG. 3 is a diagram illustrating a process of transmitting content between user terminals around a wireless communication module according to an exemplary embodiment of the present invention;

FIG. 4 is a diagram showing a screen of a first user terminal which displays an adjacent user list according to an exemplary embodiment of the present invention; and

FIG. 5 is a diagram showing a screen of a first user terminal or a second user terminal which displays content transmitted between the first user terminal and the second user terminal according to an exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention. To clearly describe the present invention, elements unrelated to the description are omitted in the drawings, and like numbers refer to like elements throughout this specification.

In this specification, when an element is referred to as being “connected to” another element, it can be directly connected to another element or indirectly connected to the other element with one or more elements interposed therebetween. Also, when an element is referred to as “including” a component, it does not preclude the presence of another component but rather specifies the presence of another component unless stated otherwise.

Hereinafter, exemplary embodiments of the present invention will be described in detail with reference to the accompanying drawings.

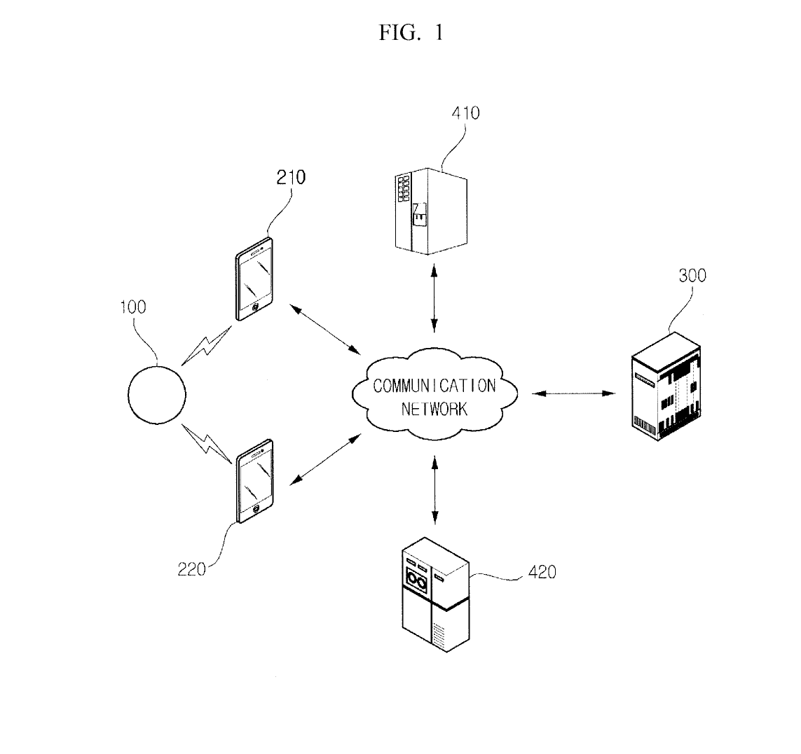

FIG. 1 is a diagram showing a content transmission system according to an exemplary embodiment of the present invention.

Referring to FIG. 1, a content transmission system according to an exemplary embodiment of the present invention may include a wireless communication module 100, a first user terminal 210, a second user terminal 220, a service providing server 300, a first application management server 410, and a second application management server 420 capable of communicating with each other through wireless communication or a communication network.

First, the wireless communication module 100 is a module for performing wireless communication according to the type of the wireless communication. For example, when the wireless communication is Bluetooth, the wireless communication module 100 may be a beacon device, and when the wireless communication is near field communication (NFC), the wireless communication module 100 may be a tag device and fixedly disposed at one spot.

Within a range in which wireless communication is possible, the wireless communication module 100 may be connected to another wireless communication device which performs wireless communication, and may perform communication with the other wireless communication device.

For example, when the wireless communication range is a radius of 10 m and the first user terminal 210 is within the radius of 10 m from the spot at which the wireless communication module 100 is disposed, the wireless communication module 100 may be connected to the first user terminal 210 and may perform wireless communication. At this time, the first user terminal 210 may be in a state in which a wireless communication function is activated.

Also, when the second user terminal 220 also enters the wireless communication range while the wireless communication module 100 and the first user terminal 210 are connected and perform communication with each other, the wireless communication module 100 may also be connected to the second user terminal 220 and perform communication with the second user terminal 220 while maintaining the connection with the first user terminal 210.

In other words, the wireless communication module 100 may be connected to each of a plurality of wireless communication devices which are within the wireless communication range and in which the wireless communication function has been activated, and may simultaneously perform communication with the respective wireless communication devices.

The wireless communication module 100 is a wireless communication device connected through wireless communication, and may transmit identification information. Here, the identification information is information for identifying the wireless communication module 100, and may be transmitted from the wireless communication module 100 to devices around the wireless communication module 100.

In other words, the wireless communication module 100 transmits the identification information within the wireless communication range in real time or periodically. When the first user terminal 210 is within the wireless communication range of the wireless communication module 100, the identification information may be transmitted from the wireless communication module 100 to the first user terminal 210.

The first user terminal 210 and the second user terminal 220 may include all kinds of handheld wireless communication devices, such as a cellular phone, a smart phone, a personal digital assistant (PDA), a portable multimedia player (PMP), and a tablet personal computer (PC), which may be connected to external devices such as the wireless communication module 100 through wireless communication and may be connected to external servers such as the service providing server 300, the first application management server 410, and the second application management server 420 through the communication network. The communication network may be a third generation (3G), fourth generation (4G), etc. mobile communication network, or a known wireless communication network other than a mobile communication network.

The first user terminal 210 and the second user terminal 220 may perform communication with the wireless communication module 100 connected through wireless communication (e.g., Bluetooth or NFC).

For example, when the wireless communication function is activated in the first user terminal 210, the first user terminal 210 may detect devices whose wireless communication function has been activated within the wireless communication range. When the first user terminal 210 moves and detects the wireless communication module 100 fixed at the specific spot, the first user terminal 210 and the wireless communication module 100 may be connected and communicate with each other.

The first user terminal 210 and the second user terminal 220 may receive the identification information from the wireless communication module 100 connected through wireless communication, recognize the wireless communication module 100 using the identification information, and find distances from the wireless communication module 100 using signal strengths of the wireless communication.

The first user terminal 210 and the second user terminal 220 may download and install a content management application in memories. Here, the content management application may manage content in a variety of forms, such as a text file, an image file, a voice file, and a multimedia file, and may provide various services related to a content management service, such as content registration and content transmission.

According to an exemplary embodiment of the present invention, an application providing server (not shown) may provide an application store capable of distributing various applications, (e.g., App Store or Google Play). When an administrator who manages the service providing server 300 registers the content management application in the application store, the first user terminal 210 and the second user terminal 220 may download the content management application from the application store and install the content management application.

According to another exemplary embodiment of the present invention, the first user terminal 210 and the second user terminal 220 may access a web page provided by the service providing server 300 and then download and install a content management application provided by the web page.

A process performed by the content management application installed in the first user terminal 210 and the second user terminal 220 will be described below, but needless to say, the whole process may be performed by the first user terminal 210 and the second user terminal 220 themselves without the content management application.

The first user terminal 210 may be connected to the wireless communication module 100 within the wireless communication range and may perform communication. At this time, the first user terminal 210 may receive the identification information from the wireless communication module 100 and recognize the wireless communication module 100.

When the wireless communication module 100 is recognized, the first user terminal 210 may transmit the identification information of the recognized wireless communication module 100 to the service providing server 300, receive an adjacent user list of the wireless communication module 100 from the service providing server 300, and display the adjacent user list on a screen.

When a second user who is at least one user in the adjacent user list is selected, the first user terminal 210 may transmit selection information of the second user to the service providing server 300.

When content to be transmitted to the second user is input or selected, the first user terminal 210 may transmit the input or selected content to the second user terminal 220. At this time, the first user terminal 210 may transmit content which is newly input by a first user to the second user terminal 220 and transmit content which is selected from content stored in a memory by the first user to the second user terminal 220.

When transmitting the content, the first user terminal 210 may transmit a content transmission request to the service providing server 300, and the service providing server 300 may transmit the content requested for transmission to the second user terminal 220.

The first user terminal 210 may receive content requested for transmission by the second user terminal 220 from the service providing server 300 and display the content on the screen.

The second user terminal 220 may receive a notification message indicating that the second user has been selected by the first user from the service providing server 300.

The second user terminal 220 may receive the content requested for transmission by the first user terminal 210 from the service providing server 300 and display the content on a screen.

When content to be transmitted to the first user is input or selected, the second user terminal 220 may transmit the input or selected content to the first user terminal 210.

According to an exemplary embodiment of the present invention, content may be transmitted between the first user terminal 210 and the second user terminal 220 each executing the content management application provided by the service providing server 300. In other words, the content may be transmitted between the first user terminal 210 and the second user terminal 220 which execute the same application.

According to another exemplary embodiment of the present invention, content may be transmitted between the first user terminal 210 which is executing a first application provided by the first application management server 410 and the second user terminal 220 which is executing a second application provided by the second application management server 420. In other words, the content may be transmitted between the first user terminal 210 and the second user terminal 220 which are executing different applications.

It has been described above that the first user terminal 210 and the second user terminal 220 perform different functions, but this is for convenience of description and intended to describe operation of a system according to the present invention. The first user terminal 210 and the second user terminal 220 may replace functions of each other.

In other words, a case in which the first user terminal 210 may select a second user and request content transmission from the second user terminal 220 first, and the second user terminal 220 may request content transmission from the first user terminal 210 after the second user terminal 220 is selected by a first user has been described above as an example, but needless to say, the first user terminal 210 and the second user terminal 220 may replace functions of each other.

The service providing server 300 may receive the identification information of the wireless communication module 100 from a user terminal which has recognized the wireless communication module 100, and register a user account corresponding to the user terminal as an adjacent user of the wireless communication module 100.

For example, the service providing server 300 may receive the identification information of the wireless communication module 100 from the second user terminal 220 which has recognized the wireless communication module 100, register a second user account corresponding to the second user terminal 220 as an adjacent user of the wireless communication module 100, and generate an adjacent user list including the registered second user account.

Subsequently, the service providing server 300 may receive the identification information of the wireless communication module 100 from the first user terminal 210 which has recognized the wireless communication module 100, register a first user account as an adjacent user of the wireless communication module 100, and provide the adjacent user list including the previously registered second user account to the first user terminal 210.

When a second user who is at least one user in the adjacent user list is selected in the first user terminal 210, the service providing server 300 may receive selection information of the second user from the first user terminal 210.

The service providing server 300 may connect the first user account and the second user account based on the selection information of the second user received from the first user terminal 210, and transmit a notification message indicating that the first user account and the second user account have been connected to the first user terminal 210 or the second user terminal 220.

After connecting the first user account and the second user account, the service providing server 300 may control content transmission so that content is transmitted between the first user terminal 210 and the second user terminal 220.

The first application management server 410 may be a server which provides a service to a user terminal in which a first application has been installed through the first application, and the second application management server 420 may be a server which provides a service to a user terminal in which a second application has been installed through the second application.

For example, when the first application is a KakaoTalk application and installed in the first user terminal 210, the first application management server 410 may provide a KakaoTalk service to the first user terminal 210, and when the second application is a Facebook application and installed in the second user terminal 220, the second application management server 420 may provide a Facebook service to the second user terminal 220.

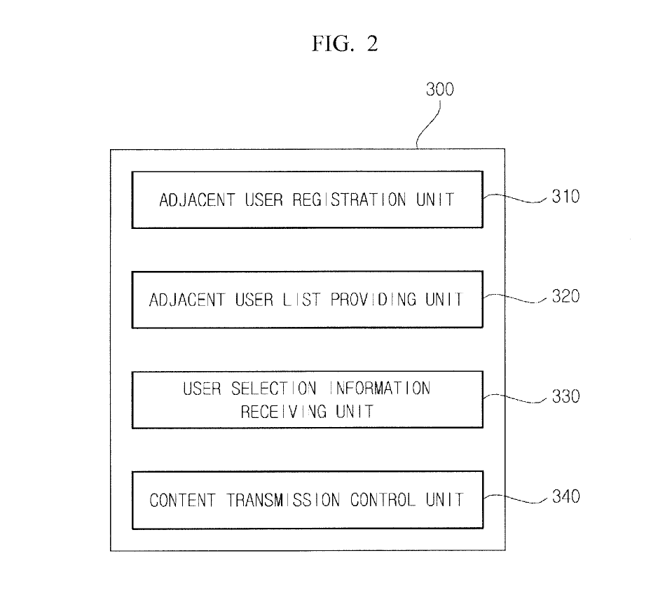

FIG. 2 is a block diagram of the service providing server 300 according to an exemplary embodiment of the present invention.

Referring to FIG. 2, the service providing server 300 may include an adjacent user registration unit 310, an adjacent user list providing unit 320, a user selection information receiving unit 330, and a content transmission control unit 340.

First, the adjacent user registration unit 310 may receive the identification information of the wireless communication module 100 from a user terminal which has recognized the wireless communication module 100, and may register a user account corresponding to the user terminal as an adjacent user of the wireless communication module 100.

For example, when a first wireless communication module is disposed in a meeting room, the adjacent user registration unit 310 may receive the identification information of the first wireless communication module from the first user terminal 210 and register a first user account as a user adjacent to the meeting room, and when a second wireless communication module is disposed in a coffee shop, the adjacent user registration unit 310 may receive the identification information of the second wireless communication module from the first user terminal 210 and register the first user account as a user adjacent to the coffee shop.

In other words, when there are a plurality of wireless communication modules 100, the adjacent user registration unit 310 may register adjacent users according to places in which the respective wireless communication modules 100 are disposed.

According to an exemplary embodiment of the present invention, a user account may be a user account of a content management application provided by the service providing server 300, but is not limited thereto. User accounts may include a user account of a first application provided by the first application management server 410, a user account of a second application provided by the second application management server 420, and so on.

For example, when the first user terminal 210 has logged into the first application with the first user account, the adjacent user registration unit 310 may receive the identification information of the wireless communication module 100 from the first user terminal 210, register the first user account having logged into the first application as an adjacent user of the wireless communication module 100, and generate an adjacent user list including the registered first user account.

Also, when the second user terminal 220 has logged into the second application with the second user account, the adjacent user registration unit 310 may receive the identification information of the wireless communication module 100 from the second user terminal 220, register the second user account having logged into the second application as an adjacent user of the wireless communication module 100, and generate an adjacent user list including the registered second user account.

In other words, the adjacent user registration unit 310 may generate an adjacent user list using only user accounts having logged in through the same application, and may also generate an adjacent user list by integrating user accounts having logged in through different applications.

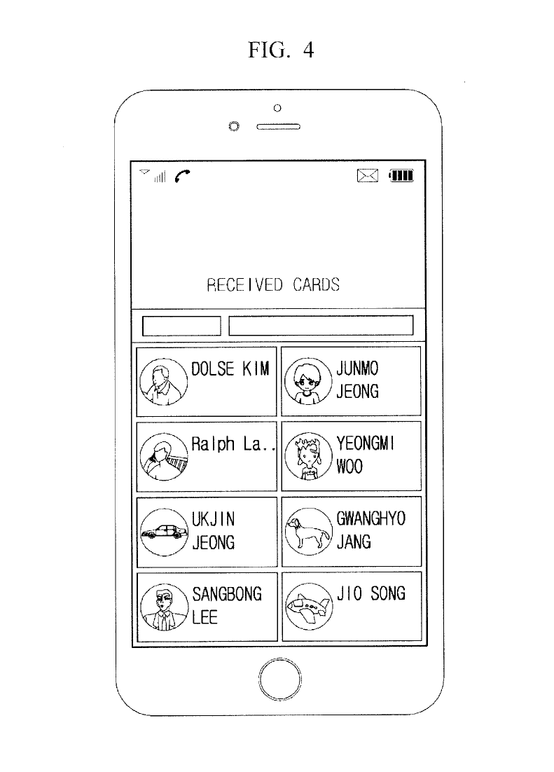

The adjacent user list providing unit 320 may provide the adjacent user list generated through registration by the adjacent user registration unit 310 to the first user terminal 210. At this time, the first user terminal 210 may display the adjacent user list in the form of a list on the screen as shown in FIG. 4.

To provide the adjacent user list, the adjacent user list providing unit 320 may use the identification information of the wireless communication module 100 received from the first user terminal 210.

In other words, the adjacent user list providing unit 320 may provide the list of adjacent users around a spot at which the wireless communication module 100 has been disposed. For example, when the second user terminal 220 has been around the wireless communication module 100 disposed in a meeting room and has been registered as an adjacent user of the meeting room in advance, if the first user terminal 210 is around the wireless communication module 100 disposed in the meeting room, the adjacent user list providing unit 320 may provide a list of users adjacent to the meeting room including the second user account to the first user terminal 210.

The adjacent user list providing unit 320 may provide an adjacent user list arranged according to distances between the wireless communication module 100, the first user terminal 210, and the second user terminal 220 based on the location information of the wireless communication module 100, the first user terminal 210, and the second user terminal 220.

According to an exemplary embodiment of the present invention, the adjacent user list providing unit 320 may provide an adjacent user list which has been arranged in order of increasing distance from the wireless communication module 100.

According to another exemplary embodiment of the present invention, the adjacent user list providing unit 320 may provide an adjacent user list which has been arranged in order of increasing distance from the first user terminal 210.

The adjacent user list providing unit 320 may provide the adjacent user list in various forms other than a list form. For example, the adjacent user list providing unit 320 may provide the adjacent user list in the form of a map in which the respective locations of the wireless communication module 100, the first user terminal 210, and the second user terminal 220 are marked based on the location information of the wireless communication module 100, the first user terminal 210, and the second user terminal 220.

The adjacent user list providing unit 320 may provide the adjacent user list by performing at least one of filtering and arrangement based on interest information set in the first user account and the second user account.

For example, for each user account, interest information may be set in advance during member registration, and the adjacent user list providing unit 320 may perform a filtering of comparing interest information set in the first user account and interest information set in the second user account, including the first or second user account in the adjacent user list when the two pieces of interest information are identical, and excluding the first or second user account from the adjacent user list when the two pieces of interest information are different, and may provide the adjacent user list which has been filtered according to the interest information. In other words, an adjacent user list including only users whose pieces of interest information, such as a keyword, are matched may be provided.

Based on interest information, the adjacent user list providing unit 320 may perform arrangement in addition to filtering. For example, the adjacent user list providing unit 320 may arrange the adjacent user list in order of users having decreasing number of interests in common and provide the adjacent user list.

When the first user terminal 210 has logged into the first application with the first user account and the adjacent user list includes the second user account having logged into the second application, the adjacent user list providing unit 320 may provide the adjacent user list including the second user account to the first user terminal 210.

In other words, the adjacent user list providing unit 320 may provide the adjacent user list including the second user account which has logged into the second application to the first user terminal 210 which is executing the first application.

From the first user terminal 210, the user selection information receiving unit 330 may receive the selection information of a second user who is at least one user in the adjacent user list provided by the adjacent user list providing unit 320. At this time, at least one second user may be selected from the adjacent user list.

When the user selection information receiving unit 330 receives the selection information of the second user from the first user terminal 210, the content transmission control unit 340 may connect the first user account and the second user account. At this time, the content transmission control unit 340 may provide the second user terminal 220 with an interface for selecting agreement on a connection with the first user account. When the agreement on a connection with the first user account is selected, the first user account and the second user account may be connected.

After the first user account and the second user account are connected, the content transmission control unit 340 may control content transmission so that content is transmitted between the first user terminal 210 and the second user terminal 220. In other words, the content transmission control unit 340 may transmit content which has been requested for transmission by the first user terminal 210 to the second user terminal 220, and transmit content which has been requested for transmission by the second user terminal 220 to the first user terminal 210.

According to an exemplary embodiment of the present invention, when the first user terminal 210 has logged in through the first application and the second user terminal 220 has logged in through the second application, the content transmission control unit 340 may connect the first user account having logged into the first application and the second user account having logged into the second application and control content transmission so that content is transmitted between the first application and the second application.

In other words, the content transmission control unit 340 may transmit content which has been requested for transmission by the first user terminal 210 executing the first application to the second user terminal 220 which is executing the second application, and may transmit content which has been requested for transmission by the second user terminal 220 executing the second application to the first user terminal 210 which is executing the first application. At this time, the content transmission control unit 340 may control the content transmission so that the transmitted pieces of content are displayed through the applications respectively executed by the first user terminal 210 and the second user terminal 220, or are separately displayed through push messages.

According to another exemplary embodiment of the present invention, the content transmission control unit 340 may control content transmission so that content transmitted between the first user terminal 210 and the second user terminal 220 is displayed in a chat window accessed by the first user account and the second user account.

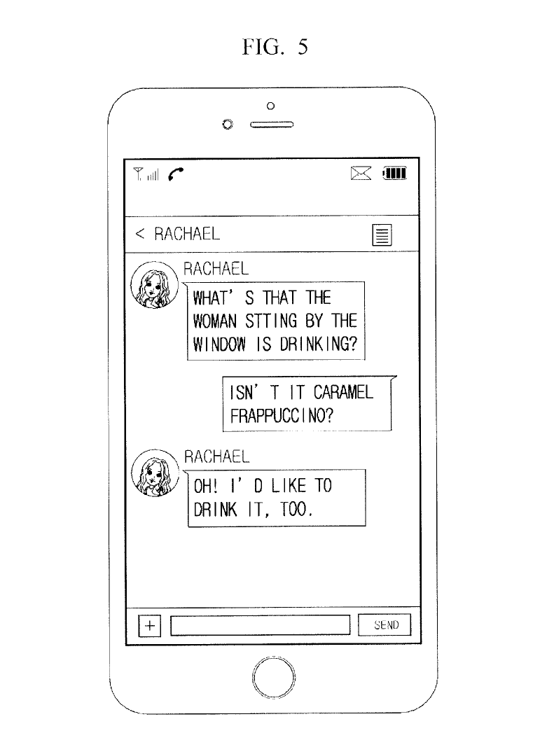

For example, when the first user account and the second user account are connected, the first user terminal 210 and the second user terminal 220 may access one chat window through the content management application provided by the service providing server 300, and content transmitted between the first user terminal 210 and the second user terminal 220 may be displayed in the one chat window as shown in FIG. 5. In other words, only the first user and the second user can obtain the content transmitted between the first user terminal 210 and the second user terminal 220.

FIG. 5 shows only an example of a message exchange between a first user and a second user, but needless to say, it is possible to exchange content other than messages, for example, business cards, documents, and images.

According to another exemplary embodiment of the present invention, the content transmission control unit 340 may control content transmission so that content transmitted between the first user terminal 210 and the second user terminal 220 is displayed in an online bulletin board provided to adjacent users of the wireless communication module 100. In other words, the content transmitted between the first user terminal 210 and the second user terminal 220 may be obtained by all users who have been registered as the adjacent users of the wireless communication module 100.

The content transmission control unit 340 may control content transmission so that the content is transmitted between the first user terminal 210 and the second user terminal 220 even when at least one of the first user account and the second user account is released from adjacent users of the wireless communication module 100 after the first user account and the second user account are connected.

In other words, once the first user account and the second user account are connected, even if the first user terminal 210 and the second user terminal 220 are not adjacent to the wireless communication module 100, the content transmission control unit 340 may control the content transmission so that the content is transmitted between the first user terminal 210 and the second user terminal 220.

For example, when the location of the first user terminal 210 is moved and wireless communication between the first user terminal 210 and the second user terminal 220 is terminated, the content transmission control unit 340 may release the first user account from adjacent users of the wireless communication module 100. Even if the first user account is released from the adjacent users, the content transmission control unit 340 may control the content transmission so that the content is transmitted between the first user terminal 210 and the second user terminal 220.

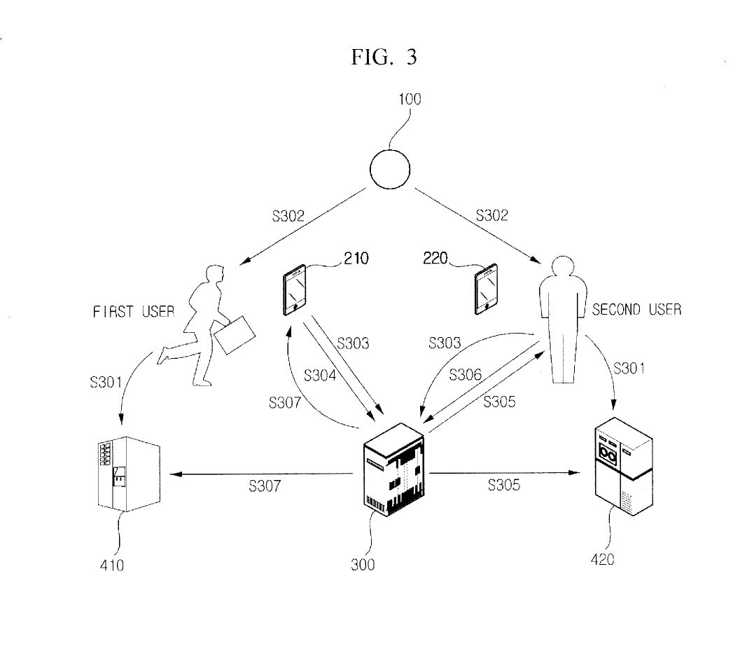

FIG. 3 is a diagram illustrating a process of transmitting content between user terminals around the wireless communication module 100 according to an exemplary embodiment of the present invention.

In FIG. 3, a first application and a second application may be the same application which enables provision of an adjacent user list and transmission of content between adjacent users according to an exemplary embodiment of the present invention.

Alternatively, the first application and the second application may be different applications.

According to an exemplary embodiment, at least one of the first application and the second application may be an application providing a commercialized social network service (SNS). For example, the first application may be the KakaoTalk application providing a commercialized SNS, and the second application may be the Facebook application providing a commercialized SNS or a dedicated application providing a service according to an exemplary embodiment of the present invention.

Meanwhile, in FIG. 3, a first user may be a user who subscribes to the first application provided by the first application management server 410, and a second user may be a user who subscribes to the second application provided by the second application management server 420. For example, when the first application is “KakaoTalk” and the second application is “Facebook,” the first user may be a user of a KakaoTalk service application, and the second user may be a user of a Facebook service application.

In operation S301, the first user terminal 210 may execute the first application and log in with a first user account, and the second user terminal 220 may execute the second application and log in with a second user account.

In operation S302, when the first user having the first user terminal 210 moves and the first user terminal 210 is located within a range in which the first user terminal 210 and the wireless communication module 100 can perform wireless communication with each other, the first user terminal 210 may be connected to the wireless communication module 100 by wireless communication, and receive identification information from the wireless communication module 100 to recognize the wireless communication module 100.

Likewise, the second user terminal 220 may also be connected to the wireless communication module 100 by wireless communication and recognize the wireless communication module 100.

According to an exemplary embodiment of the present invention, operation S301 may be performed prior to operation S302, or operation S302 may be performed prior to operation S301. In other words, the first and second user terminals 210 and 220 may be connected to the wireless communication module 100 after the application login process is performed, or the application login process may be performed after the first and second user terminals 210 and 220 are connected to the wireless communication module 100.

In operation S303, the first user terminal 210 and the second user terminal 220 may transmit the recognized identification information of the wireless communication module 100 to the service providing server 300, and the service providing server 300 may register the first user account and the second user account as adjacent users of the wireless communication module 100 to generate a list of users adjacent to the wireless communication module 100.

Subsequently, the service providing server 300 may provide the adjacent user list including the second user account to the first user terminal 210, and provide the adjacent user list including the first user account to the second user terminal 220.

In other words, the first user terminal 210 and the second user terminal 220 have logged in through different applications, but when each of the first user terminal 210 and the second user terminal 220 is around the wireless communication module 100, the first user and the second user may recognize each other as adjacent users.

For example, when the first user terminal 210 has logged into the KakaoTalk application and the second user terminal 220 has logged into the Facebook application, the service providing server 300 may provide an adjacent user list including a Facebook account of the second user to the first user terminal 210, so that the first user may recognize the Facebook account of the second user without a Facebook account.

In operation S304, the first user terminal 210 may transmit selection information of the second user to the service providing server 300, and the service providing server 300 may connect the first user account and the second user account.

After the first user account and the second user account are connected, the first user terminal 210 may transmit content which will be transmitted to the second user account to the service providing server 300. At this time, the content may be input or selected through the first application or a content management application provided by the service providing server 300.

In operation S305, the service providing server 300 may transmit the content received in operation S304 directly to the second user terminal 220, and the second user terminal 220 may display the content through the content management application provided by the service providing server 300 or may separately display the content through a push message.

Alternatively, the service providing server 300 may transmit the content received in operation S304 to the second application management server 420, and the second user terminal 220 may access the second application management server 420 through the second application and display the content through the second application.

In operation S306, the second user terminal 220 may transmit content which will be transmitted to the first user account to the service providing server 300. At this time, the content may be input or selected through the second application or the content management application provided by the service providing server 300.

In operation S307, the service providing server 300 may transmit the content received in operation S306 directly to the first user terminal 210, and the first user terminal 210 may display the content through the content management application provided by the service providing server 300 or may separately display the content through a push message.

Alternatively, the service providing server 300 may transmit the content received in operation S306 to the first application management server 410, and the first user terminal 210 may access the first application management server 410 through the first application and display the content through the first application.

As described above, according to an exemplary embodiment of the present invention, users around a wireless communication module recognize each other, so that new relationships can be easily established between the adjacent people.

In addition, according to an exemplary embodiment of the present invention, a first user who has logged into a first application can recognize a second user who has logged into a second application, and thus it is possible to recognize a user who subscribes to a different application without subscribing to and accessing the different application.

Effects of the present invention are not limited to those mentioned above, but rather, it is to be understood that effects of the present invention include all effects which can be inferred from the detailed description of the present invention or the configuration of the invention stated in the claims. Thus, it should be understood that the above-described embodiments are just examples in all aspects and are not limited. For example, elements described in a singular form may be embodied while being dispersed, and similarly, elements described to be dispersed may also be embodiment in a combined shape.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method for a service providing server to control content transmission between user terminals around a wireless communication module, the method comprising:
when identification information of the wireless communication module is received from a first user terminal having recognized the wireless communication module, registering a first user account as an adjacent user of the wireless communication module;
providing an adjacent user list of the wireless communication module to the first user terminal;
receiving selection information of a second user who is at least one user in the adjacent user list from the first user terminal; and
connecting the first user account and a second user account and controlling content transmission so that content is transmitted between the first user terminal and the second user terminal.

2. The method of claim 1, wherein the registering of the first user account as an adjacent user comprises registering the first user account having logged into a first application as an adjacent user of the wireless communication module, and
the providing of the adjacent user list comprises providing the adjacent user list including the second user account having logged into a second application to the first user terminal.

3. The method of claim 2, wherein the controlling of the content transmission comprises controlling the content transmission so that the content is transmitted between the first application and the second application.

4. The method of claim 3, wherein the controlling of the content transmission comprises controlling the content transmission so that content requested for transmission by the first user terminal through the first application is displayed in the second user terminal through the second application and content requested for transmission by the second user terminal through the second application is displayed in the first user terminal through the first application.

5. The method of claim 3, wherein the controlling of the content transmission comprises controlling the content transmission so that the content transmitted between the first application and the second application is displayed in the first user terminal and the second user terminal through a push message.

6. The method of claim 1, wherein the controlling of the content transmission comprises controlling the content transmission so that the content transmitted between the first user terminal and the second user terminal is displayed in a chat window accessed by the first user account and the second user account.

7. The method of claim 1, wherein the controlling of the content transmission comprises controlling the content transmission so that the content transmitted between the first user terminal and the second user terminal is displayed in an online bulletin board provided to adjacent users of the wireless communication module.

8. The method of claim 1, wherein the providing of the adjacent user list comprises providing the first user terminal with the adjacent user list having been subjected to at least one of filtering and arrangement based on interest information set in the first user account and the second user account.

9. The method of claim 1, wherein the providing of the adjacent user list comprises providing the first user terminal with the adjacent user list arranged according to distances between the wireless communication module, the first user terminal, and the second user terminal based on location information of the wireless communication module, the first user terminal, and the second user terminal.

10. The method of claim 1, wherein the controlling of the content transmission comprises controlling the content transmission so that the content is transmitted between the first user terminal and the second user terminal even when at least one of the first user account and the second user account is released from adjacent users of the wireless communication module after the first user account and the second user account are connected.

11. A method for a first user terminal to transmit content to a second user terminal around a wireless communication module, the method comprising:
when the first user terminal is within a wireless communication range of the wireless communication module, receiving identification information from the wireless communication module to recognize the wireless communication module;
transmitting the identification information of the wireless communication module to a service providing server and receiving an adjacent user list of the wireless communication module from the service providing server;
when a second user who is at least one user in the adjacent user list is selected, transmitting selection information of the second user to the service providing server; and
when a first user account and a second user account are connected by the service providing server, transmitting content to be transmitted to the second user account to the service providing server, so that the content is transmitted to the second user terminal.

12. A service providing server for controlling content transmission between user terminals around a wireless communication module, the service providing server comprising:
an adjacent user registration unit configured to register a first user account as an adjacent user of the wireless communication module when identification information of the wireless communication module is received from a first user terminal having recognized the wireless communication module;
an adjacent user list providing unit configured to provide an adjacent user list of the wireless communication module to the first user terminal;
a user selection information receiving unit configured to receive selection information of a second user who is at least one user in the adjacent user list from the first user terminal; and
a content transmission control unit configured to connect the first user account and a second user account and control content transmission so that content is transmitted between the first user terminal and a second user terminal.

13. The service providing server of claim 12, wherein the adjacent user registration unit registers the first user account having logged into a first application as an adjacent user of the wireless communication module, and
the adjacent user list providing unit provides the adjacent user list including the second user account having logged into a second application to the first user terminal.

14. The service providing server of claim 13, wherein the content transmission control unit controls the content transmission so that the content is transmitted between the first application and the second application.

15. The service providing server of claim 14, wherein the content transmission control unit controls the content transmission so that content requested for transmission by the first user terminal through the first application is displayed in the second user terminal through the second application and content requested for transmission by the second user terminal through the second application is displayed in the first user terminal through the first application.

16. The service providing server of claim 14, wherein the content transmission control unit controls the content transmission so that the content transmitted between the first application and the second application is displayed in the first user terminal and the second user terminal through a push message.

17. The service providing server of claim 12, wherein the content transmission control unit controls the content transmission so that the content transmitted between the first user terminal and the second user terminal is displayed in a chat window accessed by the first user account and the second user account.

18. The service providing server of claim 12, wherein the content transmission control unit controls the content transmission so that the content transmitted between the first user terminal and the second user terminal is displayed in an online bulletin board provided to adjacent users of the wireless communication module.

19. The service providing server of claim 12, wherein the adjacent user list providing unit provides the first user terminal with the adjacent user list having been subjected to at least one of filtering and arrangement based on interest information set in the first user account and the second user account.

20. The service providing server of claim 12, wherein the adjacent user list providing unit provides the first user terminal with the adjacent user list arranged according to distances between the wireless communication module, the first user terminal, and the second user terminal based on location information of the wireless communication module, the first user terminal, and the second user terminal.

21. The service providing server of claim 12, wherein the content transmission control unit controls the content transmission so that the content is transmitted between the first user terminal and the second user terminal even when at least one of the first user account and the second user account is released from adjacent users of the wireless communication module after the first user account and the second user account are connected.

22. A computer program for a first user terminal to perform:
a function of receiving identification information from a wireless communication module to recognize the wireless communication module when the first user terminal is within a wireless communication range of the wireless communication module;
a function of transmitting the identification information of the wireless communication module to a service providing server and receiving an adjacent user list of the wireless communication module from the service providing server;
a function of transmitting selection information of a second user to the service providing server when the second user who is at least one user in the adjacent user list is selected; and
a function of transmitting content to be transmitted to a second user account to the service providing server when a first user account and the second user account are connected by the service providing server, so that the content is transmitted to the second user terminal.
